(19) United States
(12) Patent Application Publication
(10) Pub. No.: US 2016/0092855 A1
(43) Pub. Date: Mar. 31, 2016

(54) Token-Based Method for Enabling Second Sale of Content Associated with a Media-Bound Content to a Consumer

(71) Applicant: Disney Enterprises. Inc., Burbank, CA (US)

(72) Inventors: Edward C. Drake, Stevenson Ranch, CA (US); James Voris, San Gabriel, CA (US)

(73) Assignee: Disney Enterprises. Inc.

(21) Appl. No.: 14/579,414

(22) Filed: Dec. 22, 2014

Related U.S. Application Data
(60) Provisional application No. 62/055,394, filed on Sep. 25, 2014.

(51) Int. Cl. G06Q 20/12; G06F 17/30

(52) U.S. Cl. CPC G06Q 20/1235; G06F 17/30377; G06F 17/30522

(57) ABSTRACT

There is provided a server including a memory configured to store a user database, the user database including a list of entitlements of a user. The server further includes a processor configured to receive a first universally unique identifier (UUID) retrieved by a playback device of the user from a medium storing a media content having a title, determine that the first UUID is registered in a repository, and inquire from the user of the playback device, in response to determining, whether the user desires to purchase an entitlement to the title associated with the first UUID, receive a reply from the user that the user desires to purchase the entitlement to the title, add the title to the list of entitlements of the user, and record a second UUID as registered in the repository, for adding the title to the list of entitlements of the user.

### RELATED APPLICATION(S)

The present application claims the benefit of and priority to a U.S. Provisional Patent Application Ser. No. 62/055,394, filed Sep. 25, 2014, and titled “A Token-Based Method for Enabling Second Sale of Media-Bound Content to a Consumer,” which is hereby incorporated by reference in its entirety into the present application.

### BACKGROUND

Methods for securely binding media, such as a movie, to physical media like a Blu-ray disc are commonplace in the market today. Users of media-bound content may wish to share their media after purchasing it, which would then allow a second user to playback the same media-bound content on a compatible device. In addition, as more and more devices are configured for connection to the Internet, authenticated users are able to stream or download movies to their devices without the requirement that the content he bound to physical media as the content is bound to a user account. Modern day media-bound content generally also includes access to a streamed or downloaded copy, which may be shared among devices associated with a single user account.

### SUMMARY

The present disclosure is directed to a token-based method for enabling second sale of content associated with a media-bound content to a consumer, substantially as shown in and/or described in connection with at least one of the figures, as set forth more completely in the claims.

### BRIEF DESCRIPTION OF THE DRAWINGS

FIG. 1 presents a system for executing a token-based method for enabling second sale of content associated with a media-bound content to a consumer, according to one implementation of the present disclosure.

FIG. 2 presents a flowchart illustrating a token-based method for enabling second sale of content associated with a media-hound content to a consumer, according to one implementation of the present disclosure.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

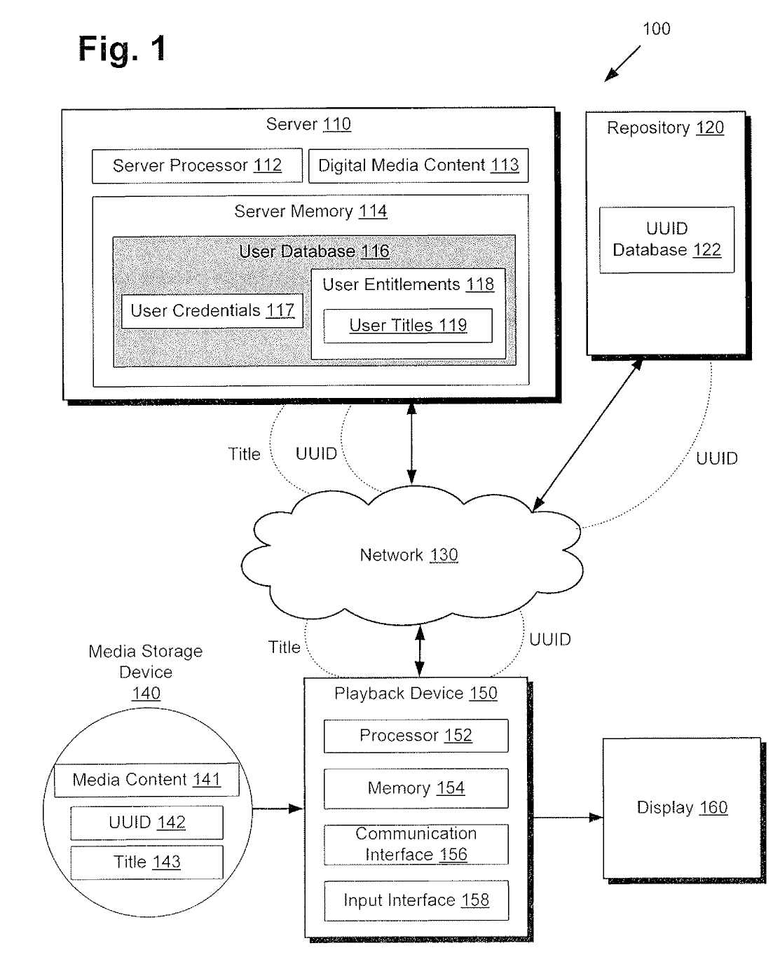

FIG. 1 presents a system utilizing a token-based method for enabling second sale of content associated with a media-bound content to a consumer, according to one implementation of the present disclosure. System 100 of FIG. 1 includes server 110, repository 120. network 130, media storage device 140, playback device 150, and display 160. Server 110 includes server processor 112, digital media content 113, and server memory 114. Server memory 114 includes user database 116 which includes user credentials 117 and user entitlements 118. User entitlements 118 include user titles 119. Repository 120 includes UUID database 122. Media storage device 140 includes media content 141, universally unique identifier (“UUID”) 142 and title. 143 of media content 141. Playback device 150 includes processor 152, memory 154, communication interface 156, and input interface 158.

Media storage device 140 may be an optical, digital, or solid state memory or storage device, for example. Media storage device 140 may alternatively be referred to as a medium. In implementations where media storage device 140 is an optical media, media storage device 140 may be a disc such as a CD, a DVD, a Blu-Ray, or a disc suitable for storing 4K/ultra-HD, for example. In implementations where media storage device 140 is a solid state media, media storage device 140 may be a hard drive or any suitable storage medium, such as playback device 150. Media storage device 140 may store a movie, a video game, an application, or any other type of media content 141. In one implementation, media storage device 140 may be a Blu-Ray disc having a movie stored thereon, and playback device 150 may be a Blu-Ray player with Internet connectivity for communicating over network 130.

As illustrated in FIG. 1, media storage device 140 includes UUID 142 associated with title 143. UUID 142 allows for registration of title 143 with a first user. Once the user registers UUID 142, title 143 of media content 141 is added to user titles 119 of user entitlements 118 in user database 116 of server 110. In addition, once the user has the entitlement to title 143, registration of UUID 142 is recorded in UUID database 122 of repository 120. UUID 142 is associated with the first user.

In one implementation, when a second user of media storage device 140 attempts to playback media content 141 stored in media storage device 140, a message may be sent to display 160 by playback device 150 inquiring from the second user if the second user would like to purchase an entitlement to media content 141 having title 143. If the second user desires to purchase an entitlement to media content 141, and completes such purchase, title 143 is added to user titles 119 and a new UUID is allocated by repository 120 for the second user and the registration of the new UUID is recorded in UUID database 122. However, in other implementations, UUID 142 may be associated with a predetermined number of users in addition to the first user, such that each future user of media storage device 140 that exceeds the predetermined number of users would require a new UUID.

UUID 142 may be in the form of an alphanumeric identifier, a uniform resource locator (“URL”), or another universally unique identifier. In some implementations, UUID 142 is embedded in media storage device 140, such as a digital fingerprint or other identifier stored within a secure memory location, and can be recognized and extracted by playback device 150. In other implementations, UUID 142 may be included as a code, for example, within printed material of packaging of media storage device 140, such as a Blu-Ray packaging. In such an implementation, the user may retrieve the code from the packaging and enter the code into playback device 150 for communication to server 110 over network 130, for example.

Playback device 150 is configured to play media content 141 on media storage device 140 and to communicate across network 130. In one implementation, playback device 150 is configured to retrieve and/or receive UUID 142 from media storage device 140, and to communicate UUID 142 across network 130 to repository 120 and server 110. Playback device 150 can be an optical disc player, such as a DVD, Blu-Ray, or 4K/Ultra-HD player, a mobile device or television, or playback device 150 can be any device capable of receiving an external media, such as an SD card. Playback device 150 may also be a digital media player stored on a hard drive of a device, such as a computer, for example.

Playback device 150 includes processor 152 and memory 154. Processor 152 is configured to execute commands, processes, or programs stored in memory 154 or communicated to processor through communication interface 156 over network 130. Processor 152 may correspond to a processing device, such as a microprocessor or similar hardware processing device, or a plurality of hardware devices. Memory 154 is a hardware memory capable of storing commands, processes, and programs for execution by processor 152. In some implementations, memory 154 may be hardware or software and may be instituted as ROM RAM, flash memory, or any sufficient memory capable of storing a set of instructions. In other implementations, memory 154 may correspond to a plurality of memory types or modules.

Playback device 150 further includes communication interface 156. Communication interface 156 is configured to allow playback device 150 to communicate over network 130 with repository 120 and server 110. Playback device 150 further includes input interface 158. Input interface 158 may comprise, for example, a keyboard, a mouse, a game controller, a touch screen input, a thermal and/or electrical sensor, or any other device capable of accepting user input for use with playback device 150. Display 160 may comprise a liquid crystal display (“LCD”), a light-emitting diode (“LED”), an organic light-emitting diode (“OLED”), or another suitable display screen that performs a physical transformation of signals to light. In the present implementation, display 160 is connected externally to playback device 150. However, in other implementations, display 160 may be built into playback device 150 and be configured for touch recognition. In such an implementation, display 160 is at least one of the devices making up input interface 158.

Network 130 provides data communications between connected devices, which in FIG. 1 include server 110, repository 120, and playback device 150. Specifically, network 130 is configured to communicate title 143 and UUID 142 between playback device 150, server 110, and repository 120. Although network 130 could represent a proprietary closed network, network 130 may also be a publicly accessible network such as the Internet, providing a wide area of coverage for playback devices at diverse locations.

Server 110 is configured to communicate with repository 120 and playback device 150 over network 130. Server 110 stores user credentials 117 and user entitlements 118, including user titles 119, in user database 116 of server memory 114. Server is configured to record title 143 under user titles 119 once server 110 determines that the user has registered UUID 142 associated with title 143 in UUID database 122 of repository 120 so that the user can access digital media content 113 without requiring media storage device 140, where digital media content 113 is associated with media content 141, and may be the same content or a different version of the same content, Server 110 may be operated by a media service provider, such as a content retailer or a content publisher. As an example, once UUID 142 and title 143, e.g., “MOVIE1,” for media content 140 of media storage device 140 are registered through repository 120 and server 110, respectively, “MOVIE1” title is added to user titles 119 in user entitlements 118, and the user can access digital media content 113 for “MOVIE1” using any device capable of connection to server 110 over network 130.

However, if UUID 142 is already registered to the user, and a second user, who does not currently have “MOVIE1” in their user titles 119 on server 110, attempts to play media content 140 from media storage device 140 using playback device 150 or another playback device, playback device 150 may restrict playing of media storage device 140 and/or inquire from the second user if they would like to purchase an entitlement to “MOVIE1.” In such a situation, if the second user desires to purchase the entitlement, a new UUID will be assigned to the second user and registered in UUID database 122, and “MOVIE1” will be added to user titles 119 for the second user.

It should be noted that the implementation of FIG. 1 illustrates only one server, however, the present disclosure is not limited to the implementation of FIG. 1. For example, in some implementations, there may be multiple servers where each server is in communication with each other server and repository 120. Each server, including server 110, may correspond to a media service provider, and the user may be registered with one or more of the media service providers. In such an implementation. repository 120 may have a universal user database for the user to create a universal login, and UUID database 122 may store the UUID's registered to the user. As such, when the user accesses one of the servers, such as server 110, server 110 communicates with repository 120 and receives notification that the user has registered UUID 142 of media storage device 140, and server 110 subsequently adds title 143 of media storage device 140 to user titles 119. If the user then accesses a different server of the multiple servers, the same process can be completed so that the user has title 143 included in user titles 119 of each server.

In yet another implementation, each of a plurality of servers, including server 110, may manage and keep track of all UUID's and user entitlements registered to each user, including UUID 142 and entitlements 118. Each of the plurality of servers may be in communication with each other server. For example, if title 143 is included in user entitlements 118 on server 110, and the user later tries to view title 143 on a second server, the second server may receive the registration information of UUID 142 from server 110, and/or receive user entitlements 118 to add to the user's entitlements on the second server. In addition, during the communication between the plurality of servers, each server may update all user entitlements 118 of the user in addition to title 143.

In one implementation, server 110 includes digital media content 113. Digital media content 113 may include some or all of the digital media content stored on server 110. Digital media content may include videos, games, applications, or any other media content type capable of being communicated over network 130. In the current implementation, digital media content 113 includes at least a digital version of media content 141 stored on media storage device 140 having a title identical to title 143. For example, if title 143 of media storage device 140 is “MOVIE1,” then digital media content 113 includes a digital version of “MOVIE1 ” for streaming, transferring, or otherwise sending to a device for playing by the user. The benefit for the user of registering UUID 142 in repository 120 and thus adding title 143 to user titles 119 is that the user can then access, such as stream, digital media content 113 at any time, from any device and location capable of communicating with server 110 over network 130.

Although digital media content 113 is shown as separate from server memory 114, in some implementations digital media content 113 may be a part of server memory 114. In addition, in some implementations, once the user has title 143 included in user titles 119, the user may he able to download a digital copy of digital media content 113 to any device capable of storing, streaming and/or playing content from digital media content 113. For example, the user may download title 143 from digital media content 113 of server 110 to a mobile phone, a computer, a media player including playback device 150, game consoles, or similar devices.

Server 110 includes server processor 112 and server memory 114. Server processor 112 is configured to execute commands, processes, or programs stored in memory 114, to execute communications over network 130, and to deliver content from digital media content 113 to playback device 150 and other devices. Server processor 112 is further configured to communicate with repository 120 and playback device 150 over network 130. Processor 112 may correspond to a processing device, such as a microprocessor or similar hardware processing device, or a plurality of hardware devices. Memory 114 is a hardware memory capable of storing commands, processes, and programs for execution by processor 112. In some implementations, memory 114 may be hardware or software and may be instituted as ROM, RAM, flash memory, or any sufficient memory capable of storing a set of instructions. In other implementations, memory 114 may correspond to a plurality of memory types or modules.

Server memory 114 includes user database 116. User database 116 is stored on server memory 114 and is configured to store user credentials 117 and user entitlements 118, including user titles 119. User credentials 117 may include a username, a password, a fingerprint, and/or any type of user authentication. For example, when the user attempts to play media content 141 from media storage device 140 on playback device 150, playback device 150 may require the user to enter a username and password through input interface 158 of playback device 150. The username and password are then communicated over network 130 to server 110 for comparison to user credentials 117 and ultimately to verify the user and access the user's user entitlements 118.

Server 110 includes user entitlements 118. User entitlements 118 are a record of what the user is entitled to, such as user titles 119, or any other information that indicates the user is entitled to a particular title. Also, if title 143 associated with UUID 142 is a special edition of media content 141. then when the user registers UUID 142, server 110 may include more user entitlements 118 associated with the user than for another user who has a UUID associated with title 143 for a normal edition of media content 141. For example, the user who registers UUID 142 may have access to behind the scenes footage in addition to a movie associated with title 143, while another user may only have access to the movie itself.

In some implementations, user entitlements 118 may be communicated from a central cloud-based record. For example, repository 120 may include universal user credentials associated with a universal user account. In such an implementation, each UUID associated with the user is recorded in UUID database 122 of repository 120. When the user accesses any media service provider server, such as server 110, server 110 can query repository 120 to determine each title associated with the universal user account, and add the titles to user titles 119 of user entitlements 118 on server 110. As such, once a title, such as title 143, is associated with a UUID, such as UUID 142, on repository 120 under the universal user account, the user can access all of the user's entitlements 118 from any media service provider server, such as user entitlements 118 on server 110.

In some implementations, once the second user purchases the new UUID and has title 143 added to user titles 119, server 110 may provide notice to the media service provider to send a copy of media content 141 stored on a media storage device to the second user. For example, if the second user purchases an entitlement to title 143 in order to access digital media content 113, the media service provider may also send a Blu-Ray disc having a copy media content 141 stored thereon to the second user. Because the new UUID is registered to the second user already, the new UUID may be burned into the Blu-Ray disc, or associated with the Blu-Ray disc, so that no other user can access the media content stored on the Blu-Ray disc without purchasing one's own entitlement.

With reference to FIG. 1, Repository 120 is configured to communicate with playback device 150 and server 110 over network 130. Repository 120 stores a record of all registered UUID's within UUID database 122, and receives UUID 142 from playback device 150. Repository 120, when queried by server 110, sends notification to server 110 about the current registration of UUID's. In addition, repository 120 is configured to allocate a new UUID in response to the user desiring to purchase an entitlement to title 143. Once repository 120 allocates the new UUID, the new UUID is associated with the user on server 110.

For example, when playback device 150 plays media content 141 from media storage device 140, and server 110 recognizes that title 143 is not included in user titles 119 for the user, server 110 queries repository 120 in order to determine if UUID 142 is registered. Repository 120, in response, determines if there is a record in UUID database 122 for the registration of UUID 142. If UUID 142 is registered, repository 120 communicates the registration to server 110, and server 110 denies access to user entitlements 118 associated with title 143. If UUID 142 is not registered, repository 120 communicates the registration to server 110, and server 110 inquires as to whether the user desires to register an entitlement to title 143 through playback device 150. If the user registers title 143, server 110 communicates the registration to repository 120, and repository 120 records UUID 142 as registered.

In some implementations, repository 120 may only record whether UUID 142 is registered or not registered, without storing the user information associated with UUID 142. However, in other implementations, repository 120 may also include the universal user credentials associated with the universal user account. In such an implementation, when the user registers UUID 142, repository 120 records the registration of UUID 142 in UUID database 122 and associates UUID 142 with the user through the universal user account. As a result, when server 110 queries repository 120, server 110 can communicate user credentials 117 to determine if the user associated with user credentials 117 matches the user associated with the universal user credentials associated with the universal user account. In other implementations, user credentials 117 requested by server 110 may be identical to the universal user credentials on repository 120, and may be communicated over network 130.

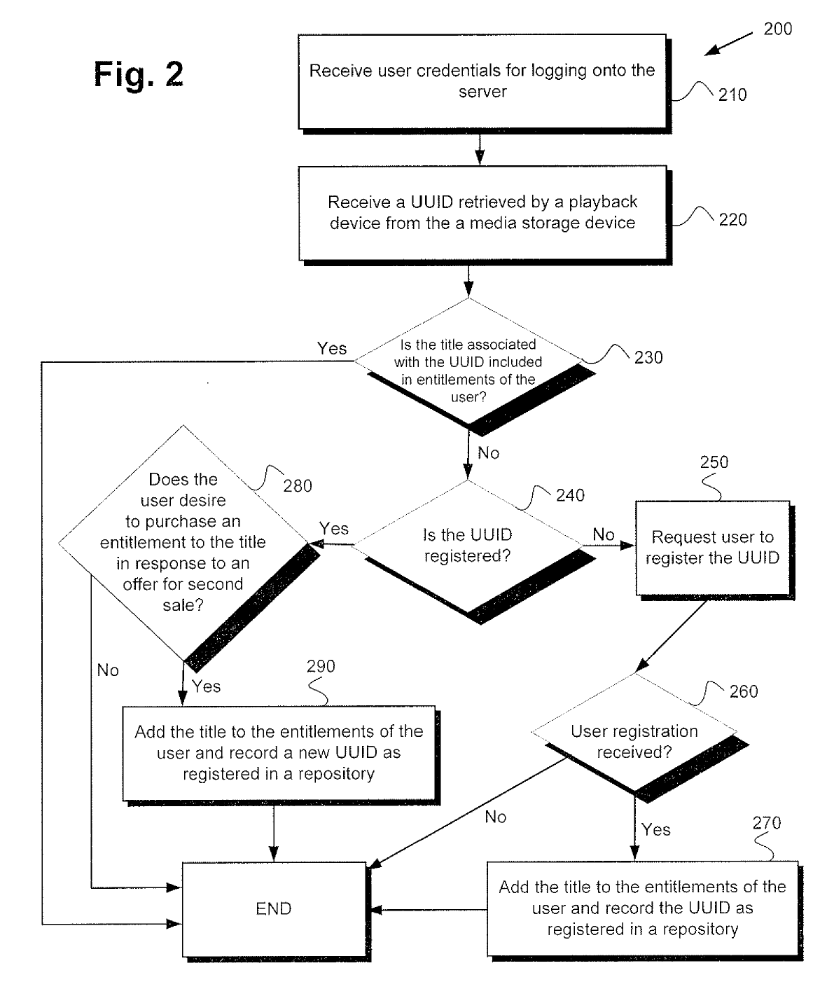

FIG. 2 presents a flowchart for a token-based method for enabling second sale of content associated with a media-bound content to a consumer, according to one implementation of the present disclosure. The approach and technique indicated by flowchart 200 are sufficient to describe at least one implementation of the present disclosure, however, other implementations of the disclosure may utilize approaches and techniques different from those shown in flowchart 200. Furthermore, while flowchart 200 is described with respect to FIG. 1, the disclosed concepts are not intended to be limited by specific features shown and described with respect to FIG. 1. Furthermore, with respect to the method illustrated in FIG. 1. it is noted that certain details and features have been left out of flowchart 200 in order not to obscure the discussion of inventive features in the present application.

Referring now to flowchart 200 of FIG. 2, flowchart 200 (at 210) includes receiving user credentials 117 for logging onto server 110. For example, when the user begins to play media content 141 from media storage device 140 using playback device 150, playback device 150 may send a signal to server 110 that the user intends to access user entitlements 118 on server 110. In response, server 110 will query playback device 150 for a username and a password, for example, to compare to user credentials 117 in order to verify access by the user.

Referring again to FIG. 2, flowchart 200 (at 220) includes receiving UUID 142 retrieved by playback device 150 from media storage device 140. After verifying user credentials 117. server 110 receives UUID 142 from playback device 150. Server 110 may query playback device 150 for UUID 142, or playback device 150 may automatically send UUID 142 in response to accessing content on media storage device 140.

Flowchart 200 (at 230) further includes determining if title 143 associated with UUID 142 is included in user entitlements 118 of the user. Server 110 after receiving UUID 142, determines if title 143 associated with UUID 142 is included in user titles 119 of user entitlements 118 in user database 116. If server 110 determines that title 143 is included in user titles 119, the user is allowed access to user entitlements 118 and no further verification is required. However, if the server determines that title 143 is not included in user title 119, the server determines if UUID 142 is registered.

Next, flowchart 200 (at 240) includes determining if UUID 142 is registered in repository 120. Server 110, after determining that title 143 is not included in user titles 119, determines if UUID 142 is registered in UUID database 122 of repository 120. If UUID 142 is not registered, then server 110 proceeds to request registration by the user (see 250 of flowchart 200, described in greater detail below). If UUID is registered, then server 110 inquires as to whether the user would like to purchase an entitlement to title 143 (see 280 of flowchart 200, described in greater detail below). In some implementations, server 110 may query repository 120 to determine if UUID 142 is registered. However, in other implementations, repository 120 may automatically communicate the registration status of UUID 142 in response to media content 141 from media storage device 140 being accessed by playback device 150 and communicated over network 130.

Flowchart 200 (at 250) continues with requesting the user to register UUID 142. Server 110 may communicate the request to playback device 150 for display on display 160. Next, flowchart 200 (at 260) includes determining if user registration was received. The user may decide not to register title 143 of media storage device 140 within user titles 119. For example, the user might have borrowed media storage device 140 from a friend and simply want to play media content 141 on media storage device 140 using playback device 150. without registering. In one implementation, if the user does not register, no communication is made to repository 120, and the user is able to play media content 141 on media storage device 140 solely using playback device 150. However, if the user decides to register title 143, server 110 adds title 143 to user titles 119 and records UUID 142 as registered in repository 120 (see 270 of flowchart 200, described in greater detail below.)

Flowchart 200 (at 270) further includes adding title 143 to user entitlements 118 and recording UUID 142 as registered in repository 120. Once the user decides to register title 143 in user database 116, title 143 is added to user titles 119 in user entitlements 118 for future access to digital media content 113 by the user. For example, if the user is not in possession of media storage device 140, the user can still access title 143 through server 110 from any media device capable of communication with server 110 over network 130. After registration, server 110 communicates the registration of title 143 by sending a record of the registration of UUID 142 to repository 120. Repository 120 then records UUID 142 as registered.

If UUID 142 was determined to be registered, at 240, then flowchart 200 continues at 280. Flowchart 200 (at 280) includes inquiring from the user if the user desires to purchase an entitlement to title 143 in response to an offer for second sale. Once server 110 determines that UUID 142 is registered, server 110 may communicate with playback device 150 to inquire from the user if the user would like to purchase an entitlement to title 143. For example, server 110 may communicate a message to display 160 for response by the user, the message reciting “Would you like to purchase ‘MOVIE1’ and add ‘MOVIE1’ to your titles?” If the user does not wish to purchase an entitlement to title 143, and thus refuses the offer for second sale, then the user may only be able to playback media content 141 from media storage device 140 using playback device 150. However, if the user purchases the entitlement to title 143, server 110 adds title 143 to user titles 119, requests a new UUID to associate with title 143 from repository 120, and the new UUID is recorded as registered in repository 120 (see 290 of flowchart 200, described in greater detail below.)

Flowchart 200 (at 290) also includes adding title 143 to user entitlements 119 of the user and recording a new UUID as registered in repository 120. If the user desires to purchase the entitlement to title 143, server 110 may request the new UUID from repository 120 and assign the new UUID to the user. As such, in one implementation, prior to adding title 143 to user entitlements 118, repository 120 allocates the new UUID, and server 110 receives the new UUID in response to the allocation. Once title 143 is added to user titles 119 in user entitlements 118, the registration status of the new UUID can be communicated to repository 120. The user may be required to enter universal user credentials into repository 120 in order to create an association of the new UUID with the user in UUID database 122. As such, once the user has purchased the entitlement, and title 143 is added to user titles 119 within user entitlements 118 on server 110, the new UUID is registered in repository 120.

In some implementations, the user may also obtain a copy of media content 141 stored on a media storage device including the new UUID. For example, the media service provider may ship a Blu-Ray disc including a copy of media content 141 and the new UUID stored on the Blu-Ray disc to the user.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the spirit and the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A server comprising:
a memory configured to store a user database, the user database including a list of entitlements of a user; and
a processor configured to:
receive a first universally unique identifier (UUID) retrieved by a playback device of the user from a medium storing a media content having a title;
determine that the first UUID is registered in a repository;
inquire from the user of the playback device, in response to determining that the first UUID is registered in the repository, whether the user desires to purchase an entitlement to the title associated with the first UUID;
receive a reply from the user, in response to inquiring, that the user desires to purchase the entitlement to the title;
add, in response to the reply, the title to the list of entitlements of the user; and
record a second UUID as registered in the repository, for adding the title to the list of entitlements of the user.

2. The server of claim 1, wherein the user database further includes credentials of the user, and wherein prior to receiving the first UUID, the processor is further configured to:
receive the credentials of the user for logging onto the server.

3. The server of claim 1, wherein after receiving the first UUID, the processor is further configured to:
determine that the title associated with the first UUID is not included in the list of entitlements of the user.

4. The server of claim 1, wherein prior to adding the title to the list of entitlements of the user, the processor is further configured to:
request an allocation of the second UUID from the repository.

5. The server of claim 1, wherein the determining that the first UUID is registered in the repository includes querying the repository to determine if the first UUID is registered in the repository.

6. The server of claim 1, wherein after adding the title to the list of entitlements of the user, the process is further configured to:
request a copy of the media content and the second UUID to be stored on a new medium for shipment to the user.

7. The server of claim 1, wherein after adding the title to the list of entitlements of the user, the user is granted access to a copy of the media content.

8. A system comprising:
a repository configured to store a plurality of UUID's; and
a server comprising:
a memory configured to store a user database, the user database including a list of entitlements of the user; and
a processor configured to:
receive the first UUID from a playback device retrieved from a medium storing a media content having a title;
determine that the first UUID is registered in the repository;
inquire from the user of the playback device, in response to determining that the first UUID is registered in the repository, whether the user desires to purchase an entitlement to the title associated with the first UUID;
add, in response to the reply, the title to the list of entitlements of the user; and
record a second UUID as registered in the repository, for adding the title to the list of entitlements of the user.

9. The system of claim 8, wherein the user database further includes credentials of the user, and wherein prior to receiving the first UUID, the processor is further configured to:
receive the credentials of the user for logging onto the server.

10. The system of claim 8, wherein after receiving the first UUID, the processor is further configured to:
determine that the title associated with the first UUID is not included in the list of entitlements of the user.

11. The system of claim 8, wherein prior to adding the title to the list of entitlements of the user, the processor is further configured to:
request an allocation of the second UUID from the repository.

12. The system of claim 8, wherein the determining that the first UUID is registered in the repository includes querying the repository to determine if the first UUID is registered in the repository.

13. The system of claim 8, wherein after adding the title to the list of entitlements of the user, the processor is further configured to:
request a copy of the media content and the second UUID to be stored on a new medium for shipment to the user.

14. The system of claim 8, wherein after adding the title to the list of entitlements of the user, the user is granted access to a copy of the media content.

15. A method for use by a server having a processor and a memory, the method comprising:
receiving, using the processor, a first (UUID) retrieved by a playback device of a user from a medium storing a media content having a title;
determining, using the processor, that the first QUID is registered in a repository;
inquiring, using the processor, from the user of the playback device, in response to determining that the first UUID is registered in the repository, whether the user desires to purchase an entitlement to the title associated with the first UUID;
receiving, using the processor, a reply from the user, in response to inquiring, that the user desires to purchase the entitlement to the title;
adding, in response to the reply, the title to a list of entitlements of the user stored in the memory; and
recording a second UUID as registered in the repository, for adding the title to the list of entitlements of the user.

16. The method of claim 15, wherein prior to receiving the first UUID the method further comprises:
receiving credentials of the user for logging onto the server.

17. The method of claim 15, wherein after receiving the first UUID, the method further comprises:
determining that the title associated with the first UUID is not included in the list of entitlements of the user.

18. The method of claim 15, wherein prior to adding the title to the list of entitlements of the user, the method further comprises:
requesting an allocation of the second UUID from the repository.

19. The method of claim 15, wherein the determining that the first UUID is registered in the repository includes querying the repository to determine if the first UUID is registered in the repository.

20. The method of claim 15, wherein after adding the title to the list of entitlements of the user, the method further comprises:
requesting a copy of the media content and the second UUID to be stored on a new medium for shipment to the user.
